(19) United States
(12) Patent Application Publication
(10) Pub. No.: US 2014/0357789 A1
(43) Pub. Date: Dec. 4, 2014

(54) SULFOPOLYESTER HAVING A CHARGE DENSITY GREATER THAN ONE AND PRODUCTS MADE THEREFROM

(71) Applicant: Eastman Chemical Company, Kingsport, TN (US)

(72) Inventors: Scott Ellery George, Kingsport, TN (US); Joshua Seth Cannon, Greeneville, TN (US); Suzanne Winegar Dobbs, Kingsport, TN (US); James Allen McCaulley, Ringoes, NJ (US)

(73) Assignee: Eastman Chemical Company, Kingsport, TN (US)

(21) Appl. No.: 13/904,374

(22) Filed: May 29, 2013

(51) Int. Cl. C08G 63/688; C09D 167/02

(52) U.S. Cl. CPC C08G 63/6886; C09D 167/02
USPC 524/603; 528/294

(57) ABSTRACT

A sulfopolyester includes the reaction product of a diacid and a diol wherein the diacid includes at least 30 mole percent of one difunctional sulfomonomer containing at least one sulfonate group bonded to an aromatic ring wherein the functional groups are carboxyl or esters thereof and a diacid moiety which is not a sulfonated aromatic moiety. The sulfopolyester composition of the present invention has a charge density of greater than 1.0 meq/g polymer solids. Another aspect of the invention is a coating composition containing from 1 to 50 weight percent of the sulfopolyester.

### BACKGROUND OF THE INVENTION

1. Field of the Invention

The present invention relates to water-dispersible polyesters and products made therefrom. More particularly, the present invention relates to linear, water-dissipatable or dispersible sulfopolyesters having a charge density greater than 1.0 meq/g of sulfopolyester and products made therefrom.

2. Description of the Prior Art

Water-dissipatable, meltable polyesters and polyesteramides derived from monomer components which include a dicarboxylic acid, hydroxycarboxylic acid, aminocarboxylic acid, aminoalcohol, glycol, diamine or combinations thereof wherein at least a part of all such monomer components is a poly(ethylene glycol), and at least part of the total monomer components is substituted with one or more sulfonate metal salt groups are well known and have been generally described in U.S. Pat. Nos. 3,734,874 and 3,779,993. Moreover, these linear sulfopolyesters have found wide-spread applications in such formulations as coatings, textiles, adhesives, personal care formulations such as cosmetics, lotions and hair-spray.

For example, U.S. Pat. No. 4,233,196 discloses a linear, water-dissipatable polymer having an inherent viscosity of at least about 0.1 and comprising the reaction products of the following components or ester forming or esteramide forming derivatives thereof; (a) at least one dicarboxylic acid; (b) at least one difunctional sulfomonomer containing at least one metal sulfonate group attached to an aromatic nucleus wherein the functional groups are hydroxy, carboxyl or amino; and (c) a glycol or a mixture of a glycol and diamine having two —NRH groups, the glycol containing two —CH₂—OH groups of which from about 0.1 to less than 15 mole percent, based on the total mole percent of hydroxyl equivalents, is a poly(ethylene glycol). Such formulation is described as used as a textile sizing material, adhesive, coating, film, packaging material and other products which can be dissolved, dispersed or otherwise dissipated in cold water, hot water, or aqueous solutions.

U.S. Pat. No. 5,290,631 discloses a water-soluble or water dispersible polyester comprising terephthalate, isophthalate, sulfoaryl dicarboxylate, ethylene glycol and polyoxyethylene glycol recurring structural units are prepared by (a) conducting a transesterification reaction (interchange) between the dimethyl terephthalate and a dimethyl sulfoaryl dicarboxylate and the ethylene glycol, the ethylene glycol/diester molar ratio advantageously ranging from 1.8 to 3.5 and preferably from 2.0 to 3.0; (b) directly esterifying the isophthalic acid with an additional amount of ethylene glycol, the ethylene glycol/isophthalic acid molar ratio advantageously ranging from 1.8 to 3.0 and preferably from 2.0 to 2.8; and (c) polycondensing the products of the aforesaid reactions.

U.S. Pat. No. 6,007,794 discloses an aerosol hair spray formulation containing 0.5 to 15 weight percent of a water-dispersible or water-dissipatible, linear sulfopolyester having a Tg of 40° C. to 50° C. and an inherent viscosity of 0.24 to 0.60 dL/g which contains repeat units from 20 to 26 mole percent dimethyl-5-sodiosulfoisophthalate and 74 to 80 mole percent isophthalic acid, based on 100 mole percent dicarboxylic acid; 10 to 30 mole percent 1,4-cyclohexanedimethanol and 70 to 90 percent diethylene glycol, based on 100 mole percent diol; and up to 60 weight percent of an alcohol.

U.S. Pat. No. 6,007,910 discloses a water-dispersible adhesive composition comprising a branched water-dispersible copolyester composition made of the reaction products; (I) 1,4-cyclohexanedicarboxylic acid; (II) about 2 to 40 mole percent, based on the total of all acid equivalents, of at least one difunctional sulfomonomer containing at least one sulfonate group bonded to an aromatic ring wherein the functional groups are carboxyl or esters thereof; (III) at least one diol or a mixture of diols; (IV) 0 to about 40 mole percent of a hydroxycarboxylic acid having one —C(R—)₂—OH group, wherein R in the reactant is hydrogen or an alkyl group of 1 to 6 carbon atoms; and (V) about 0.5 to 40 mole percent of a “multifunctional” or “branch-inducing” reactant containing at least three functional groups selected from hydroxyl, carboxyl, and mixtures thereof; wherein the copolyester containing substantially equal molar proportions of acid equivalents (100 mole percent) and diol equivalents and has an inherent viscosity is at least 0.1 dL/g measured in a 60/40 parts by weight solution of phenol/tetrachloroethane at 25° C. and at a concentration of about 0.5 g of copolyester in 100 ml of the solvent, the glass transition temperature (Tg) is no greater than 20° C., and the ring and ball softening point is at least 70° C.

Typically, sulfopolyesters are limited in their ultimate ion content by the inability to achieve adequate molecular weight due to the associated increase in melt viscosity as ion content increases. This results in microstructural inhomogeneity where the molecular weight becomes so low that significant fractions of the polymer chains do not contain sufficient numbers of ionic groups and are not water-dispersible. Consequently, aqueous dispersions of the polyester contain insoluble precipitates.

Accordingly, there is a need for a sulfopolyester having a relatively high ion content which will further result in a sulfopolyester having greater water-dispersibility and which will permit higher concentration of sulfopolyester in a hydrophilic formulation.

### SUMMARY OF THE INVENTION

A first embodiment of the present invention is a water-dispersible or water-dissipatible, linear sulfopolyester comprising the reaction product of a (I) dicarboxylic acid or derivative thereof and a (II) diol or a derivative thereof. The dicarboxylic acid or derivative thereof (I) comprises: i) greater than 30 mole percent of a difunctional sulfomonomer containing at least one sulfonate group bonded to an aromatic ring wherein the functional groups are carboxyl or esters thereof and ii) a diacid that is not a sulfonated aromatic moiety. The diol or derivative thereof comprises greater than about 15 mole percent, based on the total mole percent of hydroxyl equivalents, of a poly(ethylene glycol) having the structural formula H—(OCH₂CH₂)n-OH, wherein n is an integer of between 2 and about 500. The sulfopolyester contains substantially equimolar proportions of acid equivalents (100 mole percent) to hydroxyl equivalents (100 mole percent) and the sulfopolyester has a charge density of greater than 1.0 meq/g of sulfopolyester.

A second embodiment of the present invention is a film or coating comprising: (A) a first component comprising water; and (B) a second component comprising a sulfopolyester comprising the reaction product of a (I) dicarboxylic acid or derivative thereof and a (II) diol or a derivative thereof. The dicarboxylic acid or derivative thereof (I) comprises: i) greater than 30 mole percent of a difunctional sulfomonomer containing at least one sulfonate group bonded to an aromatic ring wherein the functional groups are carboxyl or esters thereof; and ii) a diacid that is not a sulfonated aromatic moiety. The diol has greater than about 15 mole percent, based on the total mole percent of hydroxyl equivalents, of a poly(ethylene glycol) having the structural formula H—(OCH₂CH₂)n-OH, wherein n is an integer of between 2 and about 500. The sulfopolyester contains substantially equimolar proportions of acid equivalents (100 mole percent) to hydroxyl equivalents (100 mole percent) and has a charge density of greater than 1.0 meq/g sulfopolyester. The coating composition comprises 50 weight percent to 99 weight percent of the first component, based on the total weight of the first component and the second component.

### DETAILED DESCRIPTION OF THE INVENTION

In its first embodiment, the present invention relates to water-dispersible or water-dissipatible, linear sulfopolyesters having high ion content and adequate molecular weights to provide stable dispersions without insoluble sediments. The first embodiment of the present invention provides a sulfopolyester comprising the reaction product of a (I) dicarboxylic acid or derivative thereof and (II) a diol or a derivative thereof. The dicarboxylic acid or derivative thereof (I) comprises: i) greater than 30 mole percent of a difunctional sulfomonomer containing at least one sulfonate group bonded to an aromatic ring wherein the functional groups are carboxyl or esters thereof; and ii) a diacid that is not a sulfonated aromatic moiety. The diol or derivative thereof comprises greater than about 15 mole percent, based on the total mole percent of hydroxyl equivalents, of a poly(ethylene glycol) having the structural formula H—(OCH₂CH₂)n-OH, wherein n is an integer of between 2 and about 500. The sulfopolyester contains substantially equimolar proportions of acid equivalents (100 mole percent) to hydroxyl equivalents (100 mole percent) and the sulfopolyester has a charge density of greater than 1.0 meq/g of sulfopolyester.

Unless otherwise indicated, all numbers expressing quantities of ingredients, properties such as molecular weight, reaction conditions, and so forth used herein are to be understood as being modified in all instances by the term “about.” Accordingly, unless indicated to the contrary, the numerical parameters used herein are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, the singular forms “a”, “an”, and “the” include plural referents unless the context clearly dictates otherwise. For example, reference to the reaction product of a diacid and a diol is intended to include the reaction product of one or multiple diacids with one or multiple diols.

As used herein, the term “water-dispersible” and “water-dissipatible” refer to the activity of 100% water or aqueous media (having from 10 to less than 100% water) on the sulfopolyester. The terms are specifically intended to cover those situations wherein the solution dissolves and/or disperses the polyester therein to include the formation of a true solution as well as a stable dispersion of polymer particles within an aqueous medium. Due to the statistical nature of synthetic polyesters it is possible to have both soluble and dispersible fractions when a single sulfopolyester is acted upon by water or aqueous medium.

The sulfopolyester of the present invention comprises the reaction product of a (I) dicarboxylic acid or derivative thereof and a (II) diol or a derivative thereof. The dicarboxylic acid (I) comprises: i) greater than 30 mole percent of a difunctional sulfomonomer containing at least one sulfonate group bonded to an aromatic ring wherein the functional groups are carboxyl or esters thereof; and ii) a diacid that is not a sulfonated aromatic moiety.

The difunctional sulfomonomer can be a dicarboxylic acid or ester thereof containing a metal sulfonate group or a glycol containing a metal sulfonate group or a hydroxy acid containing metal sulfonate group. In another example, the difunctional sulfomonomer can be a dicarboxylic acid or ester thereof containing a metal sulfonate group (—SO₃M) attached to an aromatic nucleus, examples of which include, but are not limited to, benzene, naphthalene, anthracene, diphenyl, oxydiphenyl, sulfonyldiphenyl, and methylenediphenyl. In yet another example, the (—SO₃M) moiety is attached to a benzene ring within an orthophthaloyl, isophthaloyl, or terephthaloyl repeat unit residue. In yet another example, the (—SO₃M) moiety is attached to a benzene ring within an isophthaloyl. Other possible examples include naphthalene, biphenyl, oxydiphenyl, sulfonyldiphenyl, and anthracene.

The cation of the sulfonate group can be one or more of the monovalent alkali metals, for example, Li⁺, Na⁺, or K⁺ and mixtures thereof. Although less preferred due to diminished water sensitivity, it is within the scope of this invention to include multivalent metals, such as Mg⁺⁺, Ca⁺⁺, Al⁺⁺⁺, Fe⁺⁺⁺. When a monovalent alkali metal ion is used, the resulting polyesters are less readily dissipated by cold water and more readily dissipated by hot water. When a divalent or a trivalent metal ion is used the resulting polyesters are not ordinarily easily dissipated by cold water but are more readily dissipated in hot water. Depending on the end use of the polymer, either of the different sets of properties may be desirable. It is possible to prepare the polyester using, for example, a sodium sulfonate salt and later by ion-exchange replace this ion with a different ion, for example, calcium, and thus alter the characteristics of the polymer. In general, this procedure is superior to preparing the polymer with divalent metal salts inasmuch as the sodium salts are usually more soluble in the polymer manufacturing components than are the divalent metal salts. Polymers containing divalent or trivalent metal ions are less elastic and rubber-like than polymers containing monovalent ions.

The sulfonate group can also be non-metallic, such as nitrogen- or phosphorous-based cations. Nitrogeneous cations may be derived from nitrogen-containing bases that may be aliphatic, cycloaliphatic or aromatic basic compounds having ionization constants in water at 25° C. of 10⁻³ to 10⁻¹⁰, preferably 10⁻⁵ to 10⁻⁸. Non-limiting examples of such nitrogen-containing bases are ammonia, dimethylethanolamine, diethanolamine, triethanolamine, pyridine, morpholine, and piperidine. Such nitrogen-containing bases and cations derived therefrom are described in U.S. Pat. No. 4,304,901, the disclosure of which is incorporated herein by reference in its entirety.

In one example, the difunctional sulfomonomer comprises 5-sodiosulfoisophthalic acid or its esters. In another example, the difunctional sulfomonomer comprises 5-sodiosulfoisophthalic acid or a dimethyl ester of 5-sodiosulfoisophthalic acid.

The dicarboxylic acid or derivative thereof comprises a diacid that is not a sulfonated aromatic moiety. The diacid that is not a sulfonated aromatic moiety can be selected from the group consisting of aliphatic, cycloaliphatic, and aromatic diacids. Examples include oxalic, malonic, succinic, glutaric, adipic, pimelic, azelaic, sebacic, fumaric, maleic, itaconic, glycolic, 1,2-cyclohexane dicarboxylic, 1,3-cyclohexane dicarboxylic, 1,4-cyclohexane dicarboxylic, phthalic, isophthalic, terephthalic, and 2,6-naphthalene dicarboxylic. In one example, the diacid that is not a sulfonated aromatic moiety is selected from the group consisting of adipic, 1,3-cyclohexane dicarboxylic, 1,4-cyclohexane dicarboxylic, and isophthalic acid. The term “dicarboxylic acid” is meant to include the corresponding esters, acid anhydrides, and acid chlorides. Preferred esters include dimethyl-1,4-cyclohexane dicarboxylate, dimethyl isophthalate, and dimethyl terephthalate. It is also contemplated that dicarboxylic acids, such as t-butyl isophthalic, 5-hydroxy isophthalic, and 4,4′-sulfonyl dibenzoic containing specialized functionalities can be employed. Dimer acids such as those available commercially are also useful in this invention.

In one example, the dicarboxylic acid or derivative thereof comprises greater than 30 mole percent of a difunctional sulfomonomer. In other examples, the dicarboxylic acid or derivative thereof can comprise greater than 40 mole percent, greater than 50 mole percent, greater than 60 mole percent, greater than 70 mole percent, or greater than 80 mole percent of a difunctional sulfomonomer.

The sulfopolyester of the present invention comprises the reaction product of a (I) dicarboxylic acid or derivative thereof and a (II) diol or a derivative thereof. The diol can comprise, for example, greater than about 15 mole percent, greater than about 20 mole percent, or greater than about 25 mole percent, based on the total mole percent of hydroxyl equivalents, of a poly(ethylene glycol) having the structural formula:

H—(OCH₂CH₂)n-OH,

wherein n is an integer of between 2 and about 500. The diol can also comprise a glycol selected from at least one of the group consisting of aliphatic, alicyclic, and aralkyl glycols. Examples of these diols include, but are not limited to, ethylene glycol, 1,2-propandiol also known in the trade as propylene glycol, 1,3-propanediol, 1,4-butanediol, 1,5-pentanediol, 1,6-hexanediol, 2,2-dimethyl-1,3-propanediol, 1,2-cyclohexane dimethanol, 1,3-cyclohexane dimethanol, 1,4-cyclohexane dimethanol, 2,2,4,4-tetramethyl-1,3-cyclobutanediol, and p-xylylenediol. Examples of suitable poly(ethylene glycols) include, but are not limited to, diethylene glycol, triethylene glycol, and tetraethylene glycol. Additional examples of suitable poly(ethylene glycols) include relatively high molecular weight poly(ethylene glycols), some of which are available commercially under the designation “Carbowax”, produced by Dow Chemical Company having molecular weights of from about 200 to about 20,000, with poly(ethylene glycols) having a molecular weight from greater than 200 to about 10,000 especially suitable for the present invention. Higher order alkyl analogs, including dipropylene glycol, dibutylene glycol, and so forth are also included in this invention. Similarly, higher order polyalkylene ether diols are useful, particularly polypropylene glycol and polytetramethylene glycol with molecular weights ranging from 200 to 10,000 g/mole. In one example, the diol comprises a glycol selected from at least one of the group consisting of ethylene glycol, cyclohexanedimethanols, 1,3-propane diol, 1,4-butane diol, 1,6-hexane diol. In another example the diol comprises 1,4-cyclohexanedimethanol and/or ethylene glycol.

In one example, the sulfopolyester comprises the reaction product of a dicarboxylic acid comprising 30 to 60 mole percent of the difunctional sulfomonomer, wherein the difunctional sulfomonomer is 5-sodiosulfoisophthalic acid and 60 to 30 mole percent of diacid that is not the sulfonate aromatic moiety, wherein the diacid that is not the sulfonate aromatic moiety is isophthalic acid and a diol comprises greater than 95 mole percent poly(ethylene glycol), wherein the poly(ethylene glycol) comprises 50 to 100 mole percent diethylene glycol and 0-50 mole percent of at least one glycol selected from the group consisting of triethylene glycol and tetraethylene glycol.

The water-dispersible sulfopolyester of the present invention has, for example, an inherent viscosity of about 0.02 dL/g to about 0.5 dL/g, about 0.05 dL/g to about 0.5 dL/g, or about 0.1 to about 0.5 dL/g, measured in a 60/40 parts by weight solution of phenol/tetrachloroethane at 25° C. and at a concentration of about 0.5 g of polymer in 100 ml of solvent.

The sulfopolyester has a charge density of greater than 1.0 milli-equivalent per gram (1.0 meq/g) of sulfopolyester. Charge density (Cd) is an absolute specification of ionic content for a sulfopolyester and is defined in terms of meq ionic groups present per gram of polymer solids. Determining Cd is performed as follows: Cd=moles sulfomonomer÷RUMW×1000, wherein RUMW is the average repeat unit molecular weight of the sulfopolyester. In other examples, the sulfopolyester has a charge density greater than about 1.1 meq/g of sulfopolyester, or greater than about 1.2 meq/g of sulfopolyester, or greater than about 1.3 meq/g of sulfopolyester, or greater than about 1.4 meq/g of sulfopolyester.

In a second embodiment, our invention provides a film or coating composition comprising: (A) a first component comprising water; and (B) a second component comprising a sulfopolyester comprising the reaction product of a (I) dicarboxylic acid or derivative thereof and a (II) diol or a derivative thereof. The dicarboxylic acid or derivative thereof (I) comprises: i) greater than 30 mole percent of a difunctional sulfomonomer containing at least one sulfonate group bonded to an aromatic ring wherein the functional groups are carboxyl or esters thereof; and ii) a diacid that is not a sulfonated aromatic moiety. The diol or derivative thereof comprises greater than about 15 mole percent, based on the total mole percent of hydroxyl equivalents, of a poly(ethylene glycol) having the structural formula H—(OCH₂CH₂)n-OH, wherein n is an integer of between 2 and about 500. The sulfopolyester contains substantially equimolar proportions of acid equivalents (100 mole percent) to hydroxyl equivalents (100 mole percent) and has a charge density of greater than 1.0 meq/g sulfopolyester. The film or coating composition comprises 50 weight percent to 99 weight percent of the first component, based on the total weight of the first component and the second component.

The description of the sulfopolyester given above for the first embodiment regarding the types of monomers and relative amounts of monomers in the diacid and diol which react to form the sulfopolyester, the viscosity of the sulfopolyester, and the charge density of the sulfopolyester apply equally well to the sulfopolyester in the film or coating composition of the second embodiment.

For example, the difunctional sulfomonomer can comprise 5-sodiosulfoisophthalic acid or its esters. In another example, the difunctional sulfomonomer can comprise 5-sodiosulfoisophthalic acid or a dimethyl ester of 5-sodiosulfoisophthalic acid.

In one example, the sulfopolyester comprises the reaction product of a dicarboxylic acid comprising 30 to 60 mole percent of the difunctional sulfomonomer, wherein the difunctional sulfomonomer is 5-sodiosulfoisophthalic acid and 60 to 30 mole percent of diacid that is not the sulfonate aromatic moiety, wherein the diacid that is not the sulfonate aromatic moiety is isophthalic acid and the diol comprises greater than 95 mole percent poly(ethylene glycol), wherein the poly(ethylene glycol) comprises 50 to 100 mole percent diethylene glycol and 0-50 mole percent of at least one glycol selected to the group consisting of triethylene glycol and tetraethylene glycol.

In one example, the dicarboxylic acid or derivative thereof comprises greater than 30 mole percent of a difunctional sulfomonomer. In other examples, the dicarboxylic acid or derivative thereof can comprise greater than 40 mole percent, greater than 50 mole percent, greater than 60 mole percent, greater than 70 mole percent, or greater than 80 mole percent of a difunctional sulfomonomer.

The water-dispersible sulfopolyester of the present invention has, for example, an inherent viscosity of about 0.02 dL/g to about 0.5 dL/g, about 0.05 dL/g to about 0.5 dL/g, or about 0.1 to about 0.5 dL/g, measured in a 60/40 parts by weight solution of phenol/tetrachloroethane at 25° C. and at a concentration of about 0.5 g of polymer in 100 ml of solvent.

For example, the sulfopolyester can have a charge density greater than about 1.1 meq/g of sulfopolyester, or greater than about 1.2 meq/g of sulfopolyester, or greater than about 1.3 meq/g of sulfopolyester, or greater than about 1.4 meq/g of sulfopolyester.

Aqueous dispersions of hyperionic sulfopolyesters are obtained by adding molten or solid polymer into water or an aqueous medium with sufficient agitation. Heating the water to less than 100° C. does not cause excessive hydrolysis of the polyester and decreases the process time to form a dispersion. Desirably, hyperionic sulfopolyesters may be dispersed at temperatures of from about 10° C. to 75° C. Advantageously, when dispersed in an aqueous medium, the sulfopolyester of the film or coating composition can have small particle sizes. For example the particle size of the sulfopolyester in the film or coating composition can be, for example, less than 20 nm, less than 15 nm, or less than 10 nm. Advantages of small particle sizes include, but are not limited to, faster dry times and greater emulsification capacity.

The film or coating composition can comprise 50 weight percent to 99 weight percent of the first component, based on the total weight of the first component and second component. Other examples of the amount of the first component in the film or coating composition include, 50 weight percent to 95 point percent, 60 weight percent to 99 weight percent, 60 weight percent to 95 weight percent, 70 weight percent to 99 weight percent, 70 weight percent to 95 weight percent of the first component, based on the total weight of the first component and the second component.

In addition to the water-dispersible or water-dissipatible, linear sulfopolyester described above, the film or coating may further contain one or more surfactants to reduce surface tension, fillers, colorants, binders and the like. Surfactants include materials otherwise known as wetting agents, anti-foaming agents, emulsifiers, dispersing agents, leveling agents etc. Surfactants can be anionic, cationic and nonionic, and many surfactants of each type are available commercially. A suitable surfactant for inclusion in these compositions possesses a critical micelle concentration sufficiently low to ensure a dried coating uncompromised by residual surfactant. The amount and number of surfactants added to the coating dispersion or composition will depend on the particular surfactant(s) selected, but should be limited to the minimum amount of surfactant that is necessary to achieve wetting of the substrate while not compromising the performance of the dried coating. For example, typical surfactant amounts can be less than or equal to about 15 weight percent based on the weight of the film or coating composition.

The film or coating composition may further include thickeners to adjust the viscosity of the formulation. One of skill in the art would readily determine and adjust the type and amounts of thickener depending on the type and amount of filler employed in the coating composition as is known in the art.

The additives described above may be supplemented with a suitable plasticizer, such as propylene glycol, dipropylene glycol, glycerin, ethoxydiglycol, triacetin, triethyl citrate, dioctyl sulfosuccinate, and selected dimethicone copolyols. Other materials that may be added include corn oil, citronella oil, olive oil, coconut oil, fragrances, dimethicone, cyclomethicone, paraffin wax, and pigments.

In one example, the film or coating composition can comprise less than 15 weight percent of at least one additive selected from the group consisting of a surfactant, filler, colorants, and binder, based on the total weight of the coating composition.

The process for making the hyperionic sulfopolyesters of the present invention utilizes one or more of the processes typically utilized in making polyesters or copolyesters and involves two distinct stages, an esterification or ester-exchange stage and a polycondensation stage. Esterification and ester-exchange reactions are advantageously conducted under an inert atmosphere, such as nitrogen, at a temperature of 150° C. to 250° C. for 0.5 to 8 hours, preferably from 180° C. to 230° C. for 1 to 4 hours at atmospheric or greater pressure. The diols, depending on their reactivities and specific process conditions employed, are used in molar excesses of 1.05 to 4 moles per total moles of diacids monomers. The second stage, polycondensation, is conducted under reduced pressure at a temperature of 220° C. to 350° C., preferably 230° C. to 300° C., and more preferably 240° C. to 290° C. for 0.1 to 6 hours, preferably 0.25 to 4 hours. Stirring or appropriate conditions are used in both stages to ensure adequate heat transfer, mass transport, and surface renewal of the reaction mixture.

To obtain the modified polymer of the present invention, the sulfonate-containing difunctional monomer may be added directly to the reaction mixture from which the polymer is made. Thus, these monomers can be used as a component in the original polymer reaction mixture. Other various processes which may be employed in preparing the novel polymers of this invention are well known in the art and are illustrated in such patents as U.S. Pat. Nos. 2,465,319; 3,018,272; 2,901,466; 3,075,952; 3,033,822; 3,033,826 and 3,033,827. These patents illustrate interchange reactions as well as polymerization or build-up processes.

The reactions for esterification and polycondensation are facilitated by appropriate catalysts and are well known in the art. For example, a suitable list of catalysts includes alkoxy, alkyl and halo titanates; alkali metal hydroxides and alcoholates; salts of organic carboxylic acids; alkyl tin compounds; metal oxides, such as antimony(III)oxide and germanium(IV)oxide; metal acetates, such as zinc acetate and aluminum acetate. In some instances the esterification stage may be autocatalytic when starting materials like terephthalic acid and isophthalic acid are used. A three-stage manufacturing procedure, similar to the disclosure of U.S. Pat. No. 5,290,631, the entire disclosure being incorporated herein by reference, may be used; particularly when a mixed monomer feed of acids and esters is employed.

The preparation of hyperionic sulfopolyesters of the present invention may be benefited by the addition of a base to form an in situ buffer to facilitate compositional control, particularly when ethylene glycol, diethylene glycol and higher order homologs are present. Preferred bases include sodium acetate, potassium acetate, lithium acetate, monosodium phosphate, dipotassium phosphate, and sodium carbonate. The base is present in an amount of less than 0.2 moles per mole of sulfomonomer, preferably in a range of 0.05 to 0.1 moles base per mole of sulfomonomer. As indicated previously, the added base or lack thereof is a useful method to control the glycol composition, especially where ethylene, diethylene, triethylene, tetraethylene glycols and so forth are interconverted via adventitious side reactions.

### Nonlimiting Embodiments

Embodiment A is a sulfopolyester comprising the reaction product of: (I) dicarboxylic acid or derivative thereof comprising: (i) greater than 30 mole percent of a difunctional sulfomonomer containing at least one sulfonate group bonded to an aromatic ring wherein the functional groups are carboxyl or esters thereof; and (ii) a diacid that is not a sulfonated aromatic moiety; and (II) diol or a derivative thereof wherein the diol comprises greater than about 15 mole percent based on the total mole percent of hydroxyl equivalents, of a poly(ethylene glycol) having the structural formula H—(OCH₂CH₂)n-OH, wherein n is an integer of between 2 and about 500, and wherein the sulfopolyester contains 100 mole percent of acid equivalents and 100 mole percent hydroxyl equivalents, and wherein the sulfopolyester has a charge density of greater than 1.0 meq/g of sulfopolyester.

The sulfopolyester of Embodiment A wherein the difunctional sulfomonomer comprises 5-sodiosulfoisophthalic acid, or the dimethyl ester of 5-sodiosulfoisophthalic acid.

The sulfopolyester of Embodiment A or Embodiment A with one or more of the intervening features wherein the dicarboxylic acid comprising 30 to 60 mole percent of the difunctional sulfomonomer, wherein the difunctional sulfomonomer is 5-sodiosulfoisophthalic acid and 60 to 30 mole percent of diacid that is not the sulfonate aromatic moiety, wherein the diacid that is not the sulfonate aromatic moiety is isophthalic acid and the diol comprises greater than 95 mole percent poly(ethylene glycol), wherein the poly(ethylene glycol) comprises 50 to 100 mole percent diethylene glycol and 0-50 mole percent of at least one glycol selected to the group consisting of triethylene glycol and tetraethylene glycol.

The sulfopolyester of Embodiment A or Embodiment A with one or more of the intervening features wherein the sulfopolyester has an inherent viscosity of about 0.02 dL/g to about 0.5 dL/g, about 0.05 dL/g to about 0.5 dL/g, or about 0.1 to about 0.5 dL/g, as determined in a 60/40 parts by weight solution of phenol/tetrachloroethane at 25° C. and at a concentration of about 0.50 g of polymer in 100 ml of solvent.

The sulfopolyester of Embodiment A or Embodiment A with one or more of the intervening features wherein the dicarboxylic acid or derivative thereof comprises greater than 40 mole percent or greater than 50 mole percent of said difunctional sulfomonomer.

The sulfopolyester of Embodiment A or Embodiment A with one or more of the intervening features wherein the diacid that is not a sulfonated aromatic moiety is selected from at least one of the group consisting of aliphatic, cycloaliphatic, and aromatic diacids.

The sulfopolyester of Embodiment A or Embodiment A with one or more of the intervening features wherein the charge density is greater than about 1.1 meq/g of sulfopolyester, greater than about 1.2 meq/g of sulfopolyester, or greater than about 1.4 meq/g of sulfopolyester.

The sulfopolyester of Embodiment A or Embodiment A with one or more of the intervening features wherein the diol comprises greater than about 20 mole percent of the poly(ethylene glycol).

Embodiment B is a coating composition comprising: (A) a first component comprising water, and (B) a second component comprising a sulfopolyester comprising the reaction product of: (I) dicarboxylic acid or derivative thereof comprising: (i) greater than 30 mole percent of a difunctional sulfomonomer containing at least one sulfonate group bonded to an aromatic ring wherein the functional groups are carboxyl or esters thereof; and (ii) a diacid that is not a sulfonated aromatic moiety; and (II) diol or a derivative thereof wherein the diol comprises greater than about 15 mole percent based on the total mole percent of hydroxyl equivalents, of a poly(ethylene glycol) having the structural formula H—(OCH₂CH₂)n-OH, wherein n is an integer of between 2 and about 500, and wherein the sulfopolyester contains 100 mole percent of acid equivalents and 100 mole percent hydroxyl equivalents, and wherein the sulfopolyester has a charge density of greater than 1.0 meq/g of sulfopolyester, and wherein the coating composition comprises 50 weight percent to 99 weight percent of the first component, based on the total weight of the first component and the second component.

The coating composition of Embodiment B wherein the difunctional sulfomonomer comprises 5-sodiosulfoisophthalic acid, or the dimethyl ester of 5-sodiosulfoisophthalic acid.

The coating composition of Embodiment B or Embodiment B with one or more of the intervening features wherein the dicarboxylic acid comprising 30 to 60 mole percent of the difunctional sulfomonomer, wherein the difunctional sulfomonomer is 5-sodiosulfoisophthalic acid and 60 to 30 mole percent of diacid that is not the sulfonate aromatic moiety, wherein the diacid that is not the sulfonate aromatic moiety is isophthalic acid and the diol comprises greater than 95 mole percent poly(ethylene glycol), wherein the poly(ethylene glycol) comprises 50 to 100 mole percent diethylene glycol and 0-50 mole percent of at least one glycol selected to the group consisting of triethylene glycol and tetraethylene glycol.

The coating composition of Embodiment B or Embodiment B with one or more of the intervening features wherein the sulfopolyester has an inherent viscosity of about 0.02 dL/g to about 0.5 dL/g, about 0.05 dL/g to about 0.5 dL/g, or about 0.1 to about 0.5 dL/g, as determined in a 60/40 parts by weight solution of phenol/tetrachloroethane at 25° C. and at a concentration of about 0.50 g of polymer in 100 ml of solvent.

The coating composition of Embodiment B or Embodiment B with one or more of the intervening features wherein the dicarboxylic acid or derivative thereof comprises greater than 40 mole percent or greater than 50 mole percent of said difunctional sulfomonomer.

The coating composition of Embodiment B or Embodiment B with one or more of the intervening features wherein the diacid that is not a sulfonated aromatic moiety is selected from at least one of the group consisting of aliphatic, cycloaliphatic, and aromatic diacids.

The coating composition of Embodiment B or Embodiment B with one or more of the intervening features wherein the charge density is greater than about 1.1 meq/g of sulfopolyester, greater than about 1.2 meq/g of sulfopolyester, or greater than about 1.4 meq/g of sulfopolyester.

The coating composition of Embodiment B or Embodiment B with one or more of the intervening features wherein the diol comprises greater than about 20 mole percent of the poly(ethylene glycol).

The coating composition of Embodiment B or Embodiment B with one or more of the intervening features wherein the sulfopolyester has a particle size of less than about 20 nanometers, less than 15 nm, or less than 10 nm.

The coating composition of Embodiment B or Embodiment B with one or more of the intervening features wherein the coating composition comprises 60 weight percent to 99 weight percent or 70 weight percent to 95 weight percent of the first component, based on the total weight of the first component and the second component.

The coating composition of Embodiment B or Embodiment B with one or more of the intervening features further comprising less than about 15 weight percent of at least one additive selected from the group consisting of a surfactant, filler, colorant, and binder, based on the total weight of the coating composition

The present invention is illustrated in greater detail by the specific examples presented below. It is to be understood that these examples are illustrative embodiments and are not intended to be limiting of the invention, but rather are to be construed broadly within the scope and content of the appended claims. All parts and percentages in the examples are on a weight percentage basis unless otherwise stated.

The following experimental procedures were used in producing the data for this invention.

The inherent viscosity (IV) values described were measured at 25° C. in 60/40 wt/wt phenol/tetrachloroethane. Polymer samples were dissolved in the solvent at a concentration of 0.50 g/100 mL. The viscosity of the polymer solution was determined using a Viscotek Modified Differential Viscometer. A description of the operating principles of the differential viscometers can be found in ASTM D 5225.

Differential Scanning calorimetry (DSC) procedures are well known in the art. The sample weight for this measurement was approximately 10.0+/−0.1 mg and both first and second heating scans were performed at a scan rate of 20° C./minute. A cooling scan between the first and second heating was also performed at this same rate in order to determine the presence of a crystallization peak upon cooling (Tcc). Scans were typically performed between about −50° C. and 275° C. to ensure detection of Tg and show the absence of melting peaks.

### Example 1

### Preparing Hyperionic Polyester Containing 30 Mole % Ionic Groups and Having a Charge Density Greater than 1.0 Meq/g of Polymer Solids

A 500 ml round bottom flask equipped with a ground glass head, 304 SS single blade agitator shaft, nitrogen inlet, and a sidearm was charged with 58 grams (0.35 moles) of isophthalic acid, 66.5 grams (0.15 moles) of diethylene glycol-diester of 5-sodiosulfoisophthalic acid, 106 grams (1.0 moles) of diethylene glycol, 1.0 grams (0.012 moles) sodium acetate and 1.02 ml of a 0.98% (w/v) solution of titanium (IV) isopropoxide in n-butanol. The flask was purged and evacuated 2 times with nitrogen before immersion in a Belmont metal bath at 200° C. Esterification was allowed to proceed with evolution of water under a 0.2 standard cubic feet per hour (scfh) nitrogen sweep for 75 minutes; and an additional 120 minutes at 220° C. with agitation at 200 rpm. The temperature was increased to 250° C., the nitrogen sweep was stopped and a vacuum of 0.3 mm was instituted for 20 minutes to perform polycondensation. The vacuum was then displaced with nitrogen and the flask was removed from the metal bath. The clear, dark amber polymer melt was allowed to cool before recovery. The polymer had an inherent viscosity of 0.171 dL/g determined at a concentration of 0.5 g/100 ml in 60/40 phenol/tetrachloroethane solvent. Thermal analysis by DSC provided a Tg of 39° C. (second scan).

### Example 2

### Preparing Hyperionic Polyester Containing 50 Mole % Ionic Groups and Having a Charge Density Greater than 1.0 Meq/g of Polymer Solids

The same apparatus as described in EXAMPLE 1 above was charged with 41.5 grams (0.25 moles) of isophthalic acid, 111 grams (0.25 moles) of diethylene glycol-diester of 5-sodiosulfoisophthalic acid, 132 grams (1.25 moles) of diethylene glycol, 50 grams (0.25 moles) poly(ethylene glycol), MW=200, 1.7 grams (0.021 moles) sodium acetate and 1.4 ml of a 0.98% (w/v) solution of titanium(IV) isopropoxide in n-butanol. The flask was purged and evacuated 2 times with nitrogen before immersion in a Belmont metal bath at 200° C. where the esterification was allowed to proceed with evolution of water under a 0.2 standard cubic feet per hour (scfh) nitrogen sweep for 75 minutes and an additional 120 minutes at 220° C. with agitation at 200 rpm. After increasing the temperature to 240° C., the nitrogen sweep was stopped and a vacuum of 0.3 mm was instituted for 60 minutes to perform the polycondensation. The vacuum was then displaced with nitrogen and the flask was removed from the metal bath and the clear, dark amber polymer melt was allowed to cool before recovery. The polymer had an inherent viscosity of 0.136 dL/g determined at a concentration of 0.5 g/100 ml in 60/40 phenol/tetrachloroethane solvent. Thermal analysis by DSC provided a Tg of 53° C. (second scan).

### Examples 3-6

The hyperionic polyesters of Examples 3-6 were prepared in accordance with the procedure of Example 1 except for the mole percentages presented in Table 1 below.

TABLE 1

| | | 2^{nd} acid | | | | |
|---|---|---|---|---|---|---|
| Ex. | mole | and | | | Cd | |
| No. | % SIP | (mole %) | diol and (mole %) | | meq/g | Ih.V. |
| 3 | 50 | CHDA | DEG (50) | PEG 200 (50) | 1.5 | 0.128 |
| | | (50) | | | | |
| 4 | 50 | D (50) | DEG (50) | PEG 200 (50) | 1.5 | 0.117 |
| 5 | 50 | I (50) | DEG (75) | PPG 425 (25) | 1.4 | 0.102 |
| 6 | 100 | 0 | DEG | 0 | 3.0 | 0.026 |
| | | | (100) | | | |

SIP = diethylene glycol-diester of 5-sodiosulfoisophthalic acid
CHDA = 1,4 cyclohexanedicarboxylic acid
DEG = diethylene glycol
PEG 200 = poly(ethylene glycol)
I = isophthalic acid
D = adipic acid
PPG 425 = polypropylene glycol

### Comparative Example 7

### Preparing an Ionic Polyester Containing 11 Mole % Ionic Groups and Having a Charge Density Less than 1.0 Meq/g of Polymer Solids

An apparatus similar to that described in EXAMPLE 1 was charged with 148 grams (0.89 moles) of isophthalic acid, 33 grams (0.11 moles) of dimethyl ester of 5-sodiosulfoisophthalic acid, 159 grams (1.5 moles) of diethylene glycol, 36 grams (0.25 moles) 1,4-cyclohexane dimethanol, 0.9 grams (0.011 moles) sodium acetate and 5.3 ml of a 0.285% (w/v) solution of titanium(IV)isopropoxide in n-butanol. The flask was purged and evacuated 2 times with nitrogen before immersion in a Belmont metal bath at 200° C. where the esterification was allowed to proceed with evolution of water under a 0.2 standard cubic feet per hour (scfh) nitrogen sweep for 60 minutes and an additional 90 minutes at 230° C. with agitation at 200 rpm. After increasing the temperature to 280° C., the nitrogen sweep was stopped and a vacuum of 0.4 mm was instituted for 38 minutes to perform the polycondensation. The vacuum was then displaced with nitrogen and the flask was removed from the metal bath and the slightly hazy, yellow polymer melt was allowed to cool before recovery. The polymer had an inherent viscosity of 0.25 dL/g determined at a concentration of 0.5 g/100 ml in 60/40 phenol/tetrachloroethane solvent. Thermal analysis by DSC provided a Tg of 32° C. (second scan).

### Aqueous Dispersions of Polymers in Examples 1 and 2 and Comparative Example 7

Dispersions of the polymers synthesized in EXAMPLES 1 and 2 and COMPARATIVE EXAMPLE 7 were obtained by heating deionized water on a hot plate to a predetermined temperature then adding the sulfopolyester with agitation with a magnetic stir bar at 400 rpm.

The particle sizes of 10% dispersions were measured by light scattering with the results shown in Table 2 below. Particle size is decreased below 10 nm as % SSIPA is increased to greater than 30 mole % when there is an increase in charge density to >1 meg/g of polymer solids.

TABLE 2

| | Mole % | Charge Density | Particle |
|---|---|---|---|
| Example | SSIPA | (meq/g) | Size (nm) |
| 1 | 30 | 1.1 | 9 |
| 2 | 50 | 1.5 | 7 |
| C7 | 11 | 0.43 | 29 |

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

We claim:

1. A sulfopolyester comprising the reaction product of:
(I) dicarboxylic acid or derivative thereof comprising:
i) greater than 30 mole percent of difunctional sulfomonomer containing at least one sulfonate group bonded to an aromatic ring wherein the functional groups are carboxyl or esters thereof; and
ii) diacid that is not a sulfonated aromatic moiety; and
(II) diol or a derivative thereof comprising greater than about 15 mole percent, based on the total mole percent of hydroxyl equivalents, of a poly(ethylene glycol) having the structural formula H—(OCH₂CH₂)n-OH,
wherein n is an integer of between 2 and about 500, and wherein said sulfopolyester contains 100 mole percent of acid equivalents and 100 mole percent hydroxyl equivalents, and wherein said sulfopolyester has a charge density of greater than 1.0 meq/g of sulfopolyester.

2. The sulfopolyester of claim 1, wherein said dicarboxylic acid or derivative thereof comprises 30 to 60 mole percent of said difunctional sulfomonomer, wherein said difunctional sulfomonomer is 5-sodiosulfoisophthalic acid and 60 to 30 mole percent of said diacid that is not the sulfonate aromatic moiety, wherein said diacid that is not the sulfonate aromatic moiety is isophthalic acid and said diol or derivative thereof comprises greater than 95 mole percent poly(ethylene glycol), wherein said poly(ethylene glycol) comprises 50 to 100 mole percent diethylene glycol and 0 to 50 mole percent of at least one glycol selected to the group consisting of triethylene glycol and tetraethylene glycol.

3. The sulfopolyester of claim 1, wherein said sulfopolyester has an inherent viscosity of about 0.02 dL/g to about 0.5 dL/g, as determined in a 60/40 parts by weight solution of phenol/tetrachloroethane at 25° C. and at a concentration of 0.50 g of polymer in 100 ml of solvent.

4. The sulfopolyester of claim 3, wherein said sulfopolyester has an inherent viscosity of about 0.1 to about 0.5 dL/g.

5. The sulfopolyester of claim 1, wherein said dicarboxylic acid or derivative thereof comprises greater than 40 mole percent of said difunctional sulfomonomer.

6. The sulfopolyester of claim 1, wherein said dicarboxylic acid or derivative thereof comprises greater than 50 mole percent of said difunctional sulfomonomer.

7. The sulfopolyester of claim 1, wherein said diacid that is not a sulfonated aromatic moiety is selected from at least one of the group consisting of aliphatic, cycloaliphatic, and aromatic diacids.

8. The sulfopolyester of claim 5, wherein said charge density is greater than about 1.1 meq/g of sulfopolyester.

9. The sulfopolyester of claim 6 wherein said charge density is greater than about 1.4 meq/g of sulfopolyester.

10. The sulfopolyester of claim 1, wherein said diol comprises greater than about 20 mole percent of said poly(ethylene glycol).

11. A coating composition comprising:
A) a first component comprising water; and
B) a second component comprising a sulfopolyester comprising the reaction product of:
(I) dicarboxylic acid or derivative thereof comprising:
i) greater than 30 mole percent of difunctional sulfomonomer containing at least one sulfonate group bonded to an aromatic ring wherein the functional groups are carboxyl or esters thereof; and
ii) diacid that is not a sulfonated aromatic moiety; and
(II) a diol or a derivative thereof comprising greater than about 15 mole percent, based on the total mole percent of hydroxyl equivalents, of a poly(ethylene glycol) having the structural formula H—(OCH₂CH₂)n-OH,
wherein n is an integer of between 2 and about 500, and wherein said sulfopolyester contains 100 mole percent of acid equivalents and 100 mole percent hydroxyl equivalents, and wherein said sulfopolyester has a charge density of greater than 1.0 meq/g of sulfopolyester, and wherein said coating composition comprises 50 weight percent to 99 weight percent of said first component, based on the total weight of said first component and said second component.

12. The coating composition of claim 11, wherein said dicarboxylic acid or derivative thereof comprises 30 to 60 mole percent of said difunctional sulfomonomer, wherein said difunctional sulfomonomer is 5-sodiosulfoisophthalic acid and 60 to 30 mole percent of said diacid that is not the sulfonate aromatic moiety, wherein said diacid that is not the sulfonate aromatic moiety is isophthalic acid and said diol or derivative thereof comprises greater than 95 mole percent poly(ethylene glycol), wherein said poly(ethylene glycol) comprises 50 to 100 mole percent diethylene glycol and 0 to 50 mole percent of at least one glycol selected to the group consisting of triethylene glycol and tetraethylene glycol.

13. The coating composition of claim 11, wherein said sulfopolyester has a particle size of less than about 20 nanometers.

14. The coating composition of claim 11, wherein said sulfopolyester has a particle size of less than about 10 nanometers.

15. The coating composition of claim 13 wherein said sulfopolyester has a charge density greater than about 1.10 meq/g of sulfopolyester.

16. The coating composition of claim 14 wherein said sulfopolyester has a charge density greater than about 1.40 meq/g of sulfopolyester.

17. The coating composition of claim 11, wherein said dicarboxylic acid or derivative thereof comprises greater than 50 mole percent of said difunctional sulfomonomer

18. The coating composition of claim 11 wherein said coating composition comprises 60 weight percent to 99 weight percent of said first component, based on the total weight of said first component and said second component.

19. The coating composition of claim 11 wherein said coating composition comprises 70 weight percent to 95 weight percent of said first component, based on the total weight of said first component and said second component.

20. The coating of claim 11 further comprising less than about 15 weight percent of at least one additive selected from the group consisting of a surfactant, filler, colorant, and binder, based on the total weight of said coating composition.
